(19) United States
(12) Patent Application Publication
(10) Pub. No.: US 2014/0146410 A1
(43) Pub. Date: May 29, 2014

(54) Liquid Crystal Display Device and Color Filter Substrate Thereof

(71) Applicant: Shih-Hsun Lo, Shenzhen (CN)

(72) Inventor: Shih-Hsun Lo, Shenzhen (CN)

(73) Assignee: Shenzhen China Star Optoelectronics Technology Co., Ltd., Shenzhen,Gaungdong (CN)

(21) Appl. No.: 13/805,726

(22) PCT Filed: Dec. 6, 2012
(86) PCT No.: PCT/CN2012/085997

§ 371 Date: Dec. 20, 2012

(30) Foreign Application Priority Data
Nov. 29, 2012 (CN) 201220645160.8

(51) Int. Cl. G02F 1/1335

(52) U.S. Cl. CPC G02F 1/133514
USPC 359/891

(57) ABSTRACT

The present invention discloses a color filter substrate, which includes a glass substrate, a color filter layer and a light-shielding layer; the light-shielding layer at least comprising a first color-resist layer, a second color-resist layer, a third color-resist layer and a fourth color-resist layer, disposed overlapped and of different color; the first color-resist layer being a red color-resist layer, the fourth color-resist layer being a yellow color-resist layer and the light-shielding layer being black. The present invention also discloses a liquid crystal display device using the above color filter substrate. As such, the present invention can save manufacturing process of black matrix on the color filter substrate and reduce cost.

### BACKGROUND OF THE INVENTION

1. Field of the Invention

The present invention relates to the field of liquid crystal displaying techniques, and in particular to a liquid crystal display device and color filter substrate thereof.

2. The Related Arts

As liquid crystal displaying techniques undergo fast development, the liquid crystal display device (LCD) has become the main stream display device. The display theory of thin film transistor-liquid crystal display (TFT-LCD) is to use the electrical field to drive the liquid crystal to display, uses the liquid crystal and polarizer to adjust the luminance of the light and uses the color filter substrate to display color. The part that the color filter substrate displaying the color is mainly accomplished by the RGB color filter layer on the color filter substrate arranged in a matrix form. In the know technique, a black matrix (BM) must be used between the two adjacent color filter layers, and in peripheral of active area of the color filter substrate for light-shielding. Therefore, a process of manufacturing black matrix is required and the material for black matrix is higher.

Thus, it is desired to have a liquid crystal display device and color filter substrate thereof to overcome the above problems.

### SUMMARY OF THE INVENTION

The technical issue to be addressed by the present invention is to provide a liquid crystal display device and color filter substrate thereof, able to save the black matrix manufacturing process on the color filter substrate to reduce the cost.

The present invention provides a color filter substrate, which comprises: a glass substrate, a color filter layer and a light-shielding layer; the glass substrate comprising an active area and a non-active area located in the peripheral of the active area; the active area comprising a plurality of color filter areas arranged in matrix form and a first light-shielding area located between two adjacent color filter areas; the non-active area comprising a second light-shielding area; the color filter layer being correspondingly disposed in the color filter area; the light-shielding layer being correspondingly disposed in the first light-shielding area and the second light-shielding area; the light-shielding layer at least comprising a first color-resist layer, a second color-resist layer, a third color-resist layer and a fourth color-resist layer, disposed overlapped and of different color; the first color-resist layer being a red color-resist layer, the fourth color-resist layer being a yellow color-resist layer and the light-shielding layer being black.

According to a preferred embodiment of the present invention, the first color-resist layer is red color-resist layer; the second color-resist layer and the third color-resist layer are any stack of a green color-resist layer and a blue color-resist layer.

According to a preferred embodiment of the present invention, the first color-resist layer is green color-resist layer; the second color-resist layer and the third color-resist layer are any stack of a red color-resist layer and a blue color-resist layer.

According to a preferred embodiment of the present invention, the first color-resist layer is blue color-resist layer; the second color-resist layer and the third color-resist layer are any stack of a red color-resist layer and a green color-resist layer.

The present invention provides a color filter substrate, which comprises: a glass substrate, a color filter layer and a light-shielding layer; the glass substrate comprising an active area and a non-active area located in the peripheral of the active area; the active area comprising a plurality of color filter areas arranged in matrix form and a first light-shielding area located between two adjacent color filter areas; the non-active area comprising a second light-shielding area; the color filter layer being correspondingly disposed in the color filter area; the light-shielding layer being correspondingly disposed in the first light-shielding area and the second light-shielding area; the light-shielding layer at least comprising a first color-resist layer, a second color-resist layer, and a third color-resist layer, disposed overlapped and of different color.

According to a preferred embodiment of the present invention, the first color-resist layer is red color-resist layer; the second color-resist layer and the third color-resist layer are any stack of a green color-resist layer and a blue color-resist layer.

According to a preferred embodiment of the present invention, the first color-resist layer is green color-resist layer; the second color-resist layer and the third color-resist layer are any stack of a red color-resist layer and a blue color-resist layer.

According to a preferred embodiment of the present invention, the first color-resist layer is blue color-resist layer; the second color-resist layer and the third color-resist layer are any stack of a red color-resist layer and a green color-resist layer.

According to a preferred embodiment of the present invention, the light-shielding layer further comprises a fourth color-resist layer, disposed on top to overlap the third color-resist layer; the fourth color-resist layer is a yellow color-resist layer, and first color-resist layer, the second color-resist layer, the third color-resist layer and the fourth color-resist layer are all color-resist layers of different color.

The present invention provides a liquid crystal display device, which comprises: a color filter substrate, the color substrate further comprising: a glass substrate, a color filter layer and a light-shielding layer; the glass substrate comprising an active area and a non-active area located in the peripheral of the active area; the active area comprising a plurality of color filter areas arranged in matrix form and a first light-shielding area located between two adjacent color filter areas; the non-active area comprising a second light-shielding area; the color filter layer being correspondingly disposed in the color filter area; the light-shielding layer being correspondingly disposed in the first light-shielding area and the second light-shielding area; the light-shielding layer at least comprising a first color-resist layer, a second color-resist layer, and a third color-resist layer, disposed overlapped and of different color.

According to a preferred embodiment of the present invention, the first color-resist layer is red color-resist layer; the second color-resist layer and the third color-resist layer are any stack of a green color-resist layer and a blue color-resist layer.

According to a preferred embodiment of the present invention, the first color-resist layer is green color-resist layer; the second color-resist layer and the third color-resist layer are any stack of a red color-resist layer and a blue color-resist layer.

According to a preferred embodiment of the present invention, the first color-resist layer is blue color-resist layer; the second color-resist layer and the third color-resist layer are any stack of a red color-resist layer and a green color-resist layer.

According to a preferred embodiment of the present invention, the light-shielding layer further comprises a fourth color-resist layer, disposed on top to overlap the third color-resist layer; the fourth color-resist layer is a yellow color-resist layer, and first color-resist layer, the second color-resist layer, the third color-resist layer and the fourth color-resist layer are all color-resist layers of different color.

The efficacy of the present invention is that to be distinguished from the state of the art. Through disposing a light-shielding layer formed by overlapping first color-resist layer, a second color-resist layer and a third color-resist layer to replace the black matrix, the present invention can save the manufacturing process of black matrix on the color filter substrate and reduce cost.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a main schematic view showing a preferred embodiment of a color filter substrate according to the present invention;

FIG. 2 is a cross-sectional view of A-A direction shown in FIG. 1;

FIG. 3 is a schematic view showing another structure of the light-shielding layer according to the present invention; and

FIG. 4 is a schematic view showing the structure of the liquid crystal display device according to the present invention.

### DETAILED DESCRIPTION OF THE PREFERRED EMBODIMENTS

The following refers to drawings and embodiments to describe the present invention in details.

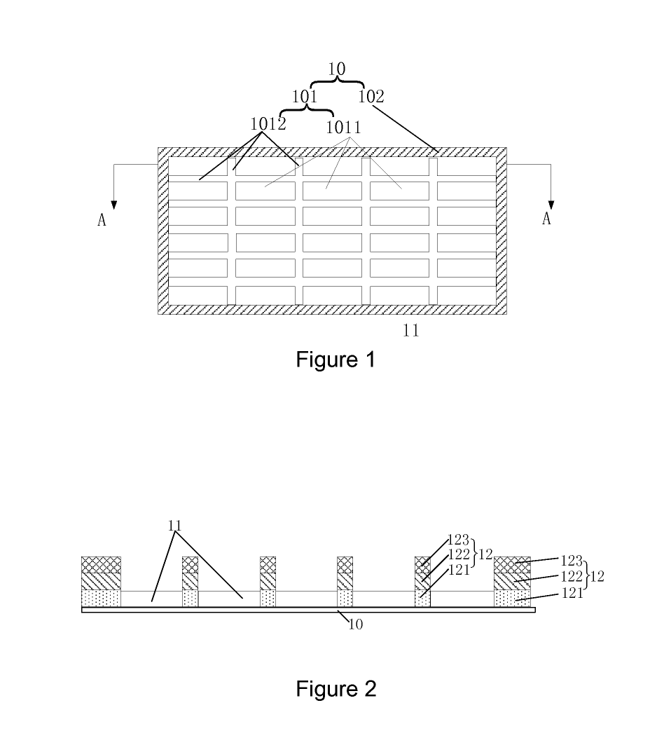

Referring to FIGS. 1-2, FIG. 1 is a main schematic view showing a preferred embodiment of a color filter substrate according to the present invention; and FIG. 2 is a cross-sectional view of A-A direction shown in FIG. 1. As shown in FIG. 2, in the present embodiment, the color filter substrate comprises a glass substrate 10, a color filter layer 11 and a light-shielding layer 12.

As shown in FIG. 1, the glass substrate 10 comprises an active area 101 and a non-active area 102. The active area 101 is preferably rectangular. The non-active area 102 is located in the peripheral of the active area 101. Specifically, the active area 101 further comprises a plurality of color filter areas 1011 and a first light-shielding area 1012. The color filter areas 1011 are arranged in matrix form inside the active area 101, and the color filter areas 1011 are preferably rectangular. The first light-shielding area 1012 is located between two adjacent color filter areas 1011. The non-active area 102 comprises a second light-shielding area (not shown).

The color filter layer 11 is correspondingly disposed in the color filter area 1011. The color filter layer 11 is arranged in a matrix form on the glass substrate 10. The floor filter layer 11 is the red, blue, green or yellow color-resist layer currently used in the known color filter substrate. For example, when the color filter layer 11 is a red color-resist layer, the light passing the color filter layer 11 appears red. When the color filter layer 11 is a color-resist layer of another color, the filtering effect is similar, and the description will not be repeated here.

The light-shielding layer 12 is correspondingly disposed in the first light-shielding area 1012 and the second light-shielding area, The light-shielding layer 12 is disposed on the glass substrate 10.

Furthermore, in the present embodiment, the light-shielding layer is preferably comprising a first color-resist layer 121, a second color-resist layer 122, and a third color-resist layer 123, disposed overlapped. The first color-resist layer 121, the second color-resist layer 122 and the third color-resist layer 123 are stacked on the glass substrate 10. In other embodiments, the number of color-resist layers can vary, and no specific restriction is imposed. In the present embodiment, the first color-resist layer 121, the second color-resist layer 122 and the third color-resist layer 123 are of different color. The material of each color-resist layer in the light-shielding layer 12 is the same as the material of the color-resist layer of the same color disposed in the color filter area 1011. It should be noted that, in the instant embodiment, the first color-resist layer 121 is preferably a red color-resist layer, the second color-resist layer 122 is preferably a green color-resist layer, and the third color-resist layer 123 is preferably a blue color-resist layer. In other embodiments, the first color-resist layer 121, the second color-resist layer 122 and the third color-resist layer 123 can be of any stack structure formed by a red color-resist layer, a green color-resist layer and a blue color-resist layer.

Table 1 shows six possible stack structure of he first, second and third color-resist layers of the light-shielding layer.

| | | Second color-resist | |
|---|---|---|---|
| | First color-resist layer | layer | Third color-resist layer |
| 1 | Red color-resist layer | Green color-resist layer | Blue color-resist layer |
| 2 | Red color-resist layer | Blue color-resist layer | Green color-resist layer |
| 3 | Green color-resist layer | Red color-resist layer | Blue color-resist layer |
| 4 | Green color-resist layer | Blue color-resist layer | Red color-resist layer |
| 5 | Blue color-resist layer | Green color-resist layer | Red color-resist layer |
| 6 | Blue color-resist layer | Red color-resist layer | Green color-resist layer |

Furthermore, the red color-resist layer, green color-resist layer and blue color-resist layer are preferred color-resist layers of three primary colors, and any stack structure will form a black light-shielding layer 12 so that the optical density of the light-shielding layer 12 achieves a higher level.

Compared to the known technique, the present embodiment disposes the stacked first color-resist layer. second color-resist layer and third color-resist layer forming a light-shielding layer to replace the black matrix, and the first color-resist layer, second color-resist layer and third color-resist layer are of three primary colors to achieve higher optical density of the light-shielding layer so as to save the manufacturing process of black matrix on the color filter substrate and reduce cost.

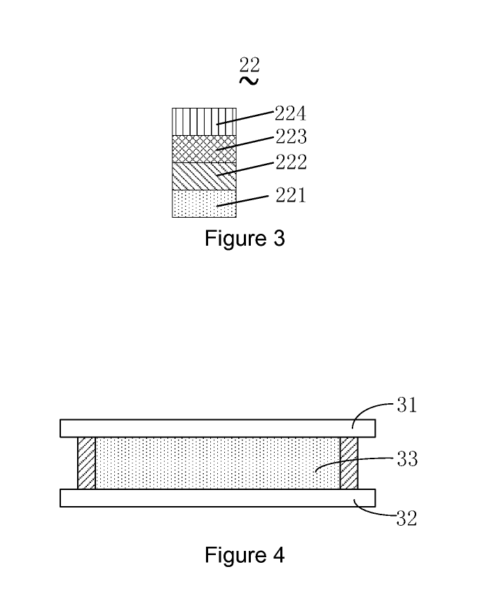

Referring to FIG. 3, FIG. 3 is a schematic view showing another structure of the light-shielding layer according to the present invention. In this embodiment, the light-shielding layer 22 comprises a first color-resist layer 221, a second color-resist layer 222, a third color-resist layer 223 and a fourth color-resist layer 224, disposed overlapped The fourth color-resist layer 224 is a yellow color-resist layer. The first color-resist layer 221, the second color-resist layer 222, the third color-resist layer 223 and the fourth color-resist layer 224 are of different color.

Referring to FIG. 4, FIG. 4 is a schematic view showing the structure of the liquid crystal display device according to the present invention. As shown in FIG. 4, the present invention further describes a liquid crystal display device. The liquid crystal display device comprises a color filter substrate 31 and an array substrate 32, disposed oppositely, and a liquid crystal layer 33 sandwiched between the color filter substrate 31 and the array substrate 32; wherein the color filter substrate 31 is a color filter substrate described in any of the previous embodiments.

In summary, compared to the known technique, the present embodiment disposes the stacked first color-resist layer, second color-resist layer and third color-resist layer forming a light-shielding layer to replace the black matrix, and the first color-resist layer, second color-resist layer and third color-resist layer are of three primary colors to achieve higher optical density of the light-shielding layer so as to save the manufacturing process of black matrix on the color filter substrate and reduce cost.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A color filter substrate, which comprises:
a glass substrate, the glass substrate comprising an active area and a non-active area located in the peripheral of the active area; the active area comprising a plurality of color filter areas arranged in matrix form and a first light-shielding area located between two adjacent color filter areas; the non-active area comprising a second light-shielding area;
a color filter layer, the color filter layer being correspondingly disposed in the color filter area; and
a light-shielding layer, the light-shielding layer being correspondingly disposed in the first light-shielding area and the second light-shielding area; the light-shielding layer at least comprising a first color-resist layer, a second color-resist layer, a third color-resist layer and a fourth color-resist layer, disposed overlapped and of different color; the first color-resist layer being a red color-resist layer, the fourth color-resist layer being a yellow color-resist layer and the light-shielding layer being black.

2. The color filter substrate as claimed in claim 1, characterized in that the first color-resist layer is red color-resist layer; the second color-resist layer and the third color-resist layer are any stack of a green color-resist layer and a blue color-resist layer.

3. The color filter substrate as claimed in claim 1, characterized in that the first color-resist layer is green color-resist layer; the second color-resist layer and the third color-resist layer are any stack of a red color-resist layer and a blue color-resist layer.

4. The color filter substrate as claimed in claim 1, characterized in that the first color-resist layer is blue color-resist layer; the second color-resist layer and the third color-resist layer are any stack of a red color-resist layer and a green color-resist layer.

5. A color filter substrate, which comprises:
a glass substrate, the glass substrate comprising an active area and a non-active area located in the peripheral of the active area; the active area comprising a plurality of color filter areas arranged in matrix form and a first light-shielding area located between two adjacent color filter areas; the non-active area comprising a second light-shielding area;
a color filter layer, the color filter layer being correspondingly disposed in the color filter area; and
a light-shielding layer, the light-shielding layer being correspondingly disposed in the first light-shielding area and the second light-shielding area; the light-shielding layer at least comprising a first color-resist layer, a second color-resist layer, and a third color-resist layer, disposed overlapped and of different color.

6. The color filter substrate as claimed in claim 5, characterized in that the first color-resist layer is red color-resist layer: the second color-resist layer and the third color-resist layer are any stack of a green color-resist layer and a blue color-resist layer.

7. The color filter substrate as claimed in claim 5, characterized in that the first color-resist layer is green color-resist layer; the second color-resist layer and the third color-resist layer are any stack of a red color-resist layer and a blue color-resist layer.

8. The color filter substrate as claimed in claim 5, characterized in that the first color-resist layer is blue color-resist layer; the second color-resist layer and the third color-resist layer are any stack of a red color-resist layer and a green color-resist layer.

9. The color filter substrate as claimed in claim 5, characterized in that the light-shielding layer further comprises a fourth color-resist layer, disposed on top to overlap the third color-resist layer; the fourth color-resist layer is a yellow color-resist layer, and first color-resist layer, the second color-resist layer, the third color-resist layer and the fourth color-resist layer are all color-resist layers of different color.

10. A liquid crystal display device, which comprises: a color filter substrate, the color filter substrate further comprising:
a glass substrate, the glass substrate comprising an active area and a non-active area located in the peripheral of the active area; the active area comprising a plurality of color filter areas arranged in matrix form and a first light-shielding area located between two adjacent color filter areas; the non-active area comprising a second light-shielding area;
a color filter layer, the color filter layer being correspondingly disposed in the color filter area; and
a light-shielding layer, the light-shielding layer being correspondingly disposed in the first light-shielding area and the second light-shielding area; the light-shielding layer at least comprising a first color-resist layer, a second color-resist layer, and a third color-resist layer, disposed overlapped and of different color.

11. The liquid crystal display device as claimed in claim 10, characterized in that the first color-resist layer is red color-resist layer; the second color-resist layer and the third color-resist layer are any stack of a green color-resist layer and a blue color-resist layer.

12. The liquid crystal display device as claimed in claim 10, characterized in that the first color-resist layer is green color-resist layer; the second color-resist layer and the third color-resist layer are any stack of a red color-resist layer and a blue color-resist layer.

13. The liquid crystal display device as claimed in claim 10, characterized in that the first color-resist layer is blue color-resist layer; the second color-resist layer and the third color-resist layer are any stack of a red color-resist layer and a green color-resist layer.

14. The liquid crystal display device as claimed in claim 10, characterized in that the light-shielding layer further comprises a fourth color-resist layer, disposed on top to overlap the third color-resist layer; the fourth color-resist layer is a yellow color-resist layer, and first color-resist layer, the second color-resist layer, the third color-resist layer and the fourth color-resist layer are all color-resist layers of different color.
